(19) United States
(12) Patent Application Publication
(10) Pub. No.: US 2011/0048153 A1
(43) Pub. Date: Mar. 3, 2011

(54) JOYSTICK

(75) Inventor: Kurt Standke, Bonn (DE)

(73) Assignee: REMA LIPPRANDT GMBH & CO. KG, Bonn (DE)

(21) Appl. No.: 12/812,909

(22) PCT Filed: Jan. 8, 2009
(86) PCT No.: PCT/EP2009/050177

§ 371 Date: Jul. 14, 2010

(30) Foreign Application Priority Data
Jan. 14, 2008 (DE) 20 2008 000 561.2
Jun. 19, 2008 (DE) 20 2008 008 259.5

(51) Int. Cl. G05G 9/04

(52) U.S. Cl. 74/471 XY

(57) ABSTRACT

A joystick (100), with first means for the mounting of a stick (1) and for bringing about forces against tilting of the stick (1) at least about a certain axis, said means comprising a stick (1) with at least one projection (2) which extends in the longitudinal direction of the stick (1) and has the outline of a semicircle reduced by half the thickness of the stick (1) and is guided in a sliding manner in a groove which is matched to the shape of the projection (2) and is provided in at least one movement module (4), which is mounted rotatably in a housing (9) of the joystick (100), with an axis of rotation.

The invention relates to a joystick with springs bringing about restoring forces, the joystick being tiltable simultaneously via two axes which are perpendicular to each other.

Joysticks of this type are widely used as control elements for, inter alia, computers, vehicles and other machines.

The majority of said joysticks have elements bringing about restoring forces. The restoring forces make it possible for the user to rapidly find the initial position of the joystick. They also provide the user with haptic feedback about the magnitude of the control signal provided by said user via the joystick.

The restoring forces are generally brought about by spring elements.

Arrangements are known in which the restoring forces are brought about by a central spring. A drawback in this case is that restoring forces of differing strength cannot be brought about for different directions of actuation of the joystick. Arrangements are also known in which the restoring forces are brought about by a plurality of decentralized springs. A disadvantage in this case in turn is that said arrangements are often complicated and prone to error.

It is the object of the invention to provide a joystick in which the restoring forces are brought about by a plurality of springs and which has a very robust and reliable construction with relatively few individual parts.

This object is achieved by the invention reproduced in claim 1. A stick is intended to be understood below as meaning the joystick rod over the entire extent thereof, even in the interior of the housing.

The joystick according to the invention comprises first means for the mounting of a stick and for bringing about forces against tilting of the stick at least about a certain axis. Said means comprise at least one projection in the lower region of the stick. The at least one projection extends in the longitudinal direction of the stick and is shaped in such a manner that the outline thereof corresponds to a semicircle which, by parallel displacement of the straight lines, is reduced by half the thickness of the stick. The at least one projection is guided in a sliding manner in a groove matched to the shape thereof. Said shape of the projection and of the groove enables the stick to tilt toward said groove and away therefrom. Each groove is arranged in a movement module mounted rotatably in a housing, with an axis of rotation, the imaginary extension of which intersects the longitudinal axis of the stick and runs perpendicularly to said longitudinal axis, as viewed from the side. By this means, the stick may be moved, as described above, toward the movement module and away therefrom, in which case the projection slides in the groove, and perpendicularly to said direction of movement, which brings about rotation of the movement module. This results in the tilting movement of the stick about an axis being transmitted/sensed, and also, when the stick is freely tiltable, about the axis perpendicular to said axis, in an extremely simple and reliable manner. Even with two oppositely arranged movement modules with grooves, the stick is mounted via the projections thereof, i.e. is also fixed in the longitudinal direction thereof. Each component of the tilting movement of the stick that is not directed toward the movement module or away therefrom is converted into a simple rotational movement of a movement module, said rotational movement being particularly suitable for producing forces which rise proportionally to the deflection. For this reason, the spring elements bringing about the restoring forces for said movement component can likewise be arranged very simply and reliably. The joystick has at least one such spring element, the force of which opposes rotation of the at least one movement module out of an initial position. In addition to the first means just described, other means are provided which bring about a force against tilting of the stick out of an initial position at least about the axis which is perpendicular to the above-mentioned axis, and therefore restoring forces are produced upon every possible tilting of the stick. It has been shown that, as a result, in comparison to bringing about a restoring force against tilting of the stick via both axes, the risk of blocking is reduced by the above-described first means, for example by four projections which are arranged at right angles to one another and have complementary grooves and movement modules.

Said other means preferably comprise a driver-bracket which is likewise mounted tiltably and is carried along by the stick during all the stick tilting movements taking place at least toward the movement module having the groove or away therefrom. In the preferred embodiment, the driver-bracket is in the form of two archways which are located one behind the other in parallel and are connected to each other by two further archways of smaller spans at the sides, wherein the stick reaches through the resultantly formed rectangle, as viewed from above. In order to fulfill its function, namely to pick up movement components of the stick that are not detected by the movement modules having a groove, the driver-bracket is arranged in such a manner that the longer extent of the rectangle runs perpendicularly to the axis of rotation of the at least one movement module having a groove. In this case, the driver-bracket is coupled to at least one spring element, the force of which opposes tilting of the driver-bracket out of an initial position. The driver-bracket designed in this manner, together with the movement modules having a groove and with complementary projections, brings about uniform restoring forces on all tilting movements of the stick. Said driver-bracket can therefore fit into the arrangement in such a manner that it permits all tilting movements of the stick without interference.

In the preferred embodiment, the driver-bracket is mounted tiltably and the restoring force is brought about by the connection thereof to at least one further movement module which is mounted rotatably in the housing of the joystick, which does not have a groove but otherwise is similar to the above-described movement module. Said movement module likewise has a spring element which brings about a spring force against rotation of the movement module out of an initial position.

In the preferred embodiment, the driver-bracket and movement module are connected in a form-fitting manner and/or by adhesive bonding to provide reliable transmission of force.

In the preferred embodiment, that side of the stick which faces the at least one further movement module connected to the driver-bracket has a projection which—particularly preferably—has the same shape and size as the above-described projection of the stick. Instead of a groove, the at least one further movement module, which is connected to the driver-bracket, has a recess on the side thereof facing the joystick, the recess being in the shape of the inner surface of a segment of a sphere, the radius of which is somewhat larger than the radius of the semicircle of the outline of the projection. Said movement module is arranged in such a manner that the corresponding projection of the joystick bears with the surface thereof which points away from the stick in a sliding manner on the recess. In this manner, the further movement modules which are connected to the driver-bracket and do not have a groove also contribute to the mounting of the stick.

The joystick expediently has two opposite movement modules with grooves, and two opposite movement modules which are arranged perpendicularly thereto and are connected to the driver-bracket, and the stick comprises four projections which are perpendicular to one another.

Spring elements are preferably provided on each movement module. Said multiple bringing about of restoring force increases the operational reliability of the joystick.

In one embodiment, the movement module is mounted rotatably at least via a sliding mounting between an outer surface of the movement module and the housing. Given a suitable selection of material—preferably special plastic with good sliding properties—this type of mounting, in view of the rather small forces which occur, can be produced to last a long time, to be maintenance-free and cost-effective. It results in a sheetlike loading of the components. At the same time, it ensures a low degree of friction and therefore comfortable actuation of the joystick.

In the preferred embodiment, the movement modules are at least also mounted on a spindle. For this purpose, a cylindrical projection is provided on the movement modules, said projection having a bore and, together with a complementary spindle which is provided on the housing and reaches through said projection, forming a sliding bearing. Such a mounting is reliable and fits readily into the overall construction of the joystick. The rotatable mounting of the movement modules and the longitudinal guidance of the projections in the groove can be provided in the form of a mounting on roller bearings or longitudinal guide.

At least one movement module is preferably provided such that it can be optionally blocked by a fixing means, which can be cancelled again, on the housing. By this means, the joystick may also be used for applications in which, at least temporarily, only tiltability via one axis is desired. Complete blocking of the joystick is also possible by this means.

The means preferably comprise a threaded bore in at least one movement module into which a blocking screw with a complementary external thread is optionally screwed through a bore in the housing of the joystick.

A leg spring is preferably provided as the spring element. This permits a particularly simple construction.

In one embodiment, the spring elements are made of plastic. In particular in the embodiment as a leg spring, adequate spring forces and an adequate permanent load-bearing capacity of the spring element may also be achieved using springs made of plastic. In comparison to spring elements made of metal, the loading peaks upon application of force into components of the joystick are reduced by this means. In addition, there is a relatively large number of different fastening options for the spring.

In the preferred embodiment, the spring elements are provided from metal to ensure particularly high robustness.

The two legs of the spring are preferably connected by at least one winding. By this means, the bending is distributed over a longer distance and the material loading drops, and in addition there is a simple installation option. The leg spring is preferably placed with the winding thereof around the projection of the movement module, said projection also being used for the mounting in the preferred embodiment. The projection reaches—particularly preferably—to a point just in front of the housing or touches the latter. In this manner, the spring cannot slip off the projection and is fitted particularly simply and reliably.

To further reduce the outlay on manufacturing, the leg spring may also be U-shaped. Since, in this embodiment, the spring cannot fully surround a projection, other means may be provided which bring about the fixing of the spring in the direction of the extent of the legs thereof. Said means may make provision for the spring together with the leg connection thereof to rest on a projection and to be prevented by an additional stop from lifting off said projection. Instead of the additional stop, a slot, into which the spring together with the leg connection thereof is placed, may also be provided in the projection.

The spring may also be shaped in such a manner that the region which lies between the legs does not fully surround the projection, but surrounds the latter by more than a semicircle, i.e. the leg connection is provided to be approximately “c-shaped”.

The leg spring may also be stuck to the movement module—preferably on a projection integrally formed in a supporting manner and only by means of the leg connection of said leg spring.

The leg springs may also be integrally formed with the movement modules—particularly preferably in the embodiment where said leg springs are made of plastic—thus resulting in an even greater reduction in the outlay on manufacturing and installation.

As further fixing means, the ends of the legs of the spring may have thickened portions which interact with stops on the housing.

A cutout is preferably provided in the movement module, the opposite borders of which cutout serve as stop points for the two legs of the spring and which, in the initial position of the stick, lie in a line with stops on the housing. By this means, the spring can be fitted in a very simple manner, and stops which have to be additionally manufactured are not required on the movement modules. With the position in which the borders of the recesses are congruent with the housing stops, this type of arrangement surprisingly simply provides an initial position in which no spring forces act on the stick. By pivoting of the stick (at least also) about the axis of rotation of a certain movement module, the cutout of said movement module is displaced against the stops of the housing. This further compresses the legs of the springs. In addition, the expanding forces of the spring no longer cancel one another out, since said expanding forces no longer act on both stop edges of the recess of the movement module. One leg of the spring now just bears against the stop edge of the movement module and the other leg against the stop of the housing. By this means, a force is brought about between the housing and the movement module by the spring, said force being transmitted to the stick, opposing the pivoting and existing until the stick is returned into the rest position.

The spring is preferably pretensioned. This enables a relatively soft spring to be used, and it is ensured that the restoring force of the spring is brought about in a play-free manner upon every rotation, however small, of the movement modules out of an initial position.

In the preferred embodiment, helical springs are provided on at least one movement module redundantly to the leg springs, for safety reasons. The restoring forces are therefore brought about jointly by the leg spring and helical spring, and therefore a restoring force still remains even if one of the springs should fail.

In the preferred embodiment, two helical springs are provided in addition to a leg spring for each movement module, said helical springs being supported on the housing base and being stressed by two drivers on the movement module.

The sensor, which produces a control signal as a function of the degree of actuation of the stick, is preferably arranged below the stick. This makes it possible for a single sensor to detect the pivoting of the stick about both axes.

Said sensor is preferably a Hall sensor which interacts with a magnet arranged on the lower side of the stick. Since the movement information of the stick is also fully reproduced in the rotation of the movement modules, corresponding decentralized sensors are also possible.

The invention will now be explained in more detail with reference to the attached drawings, in which:

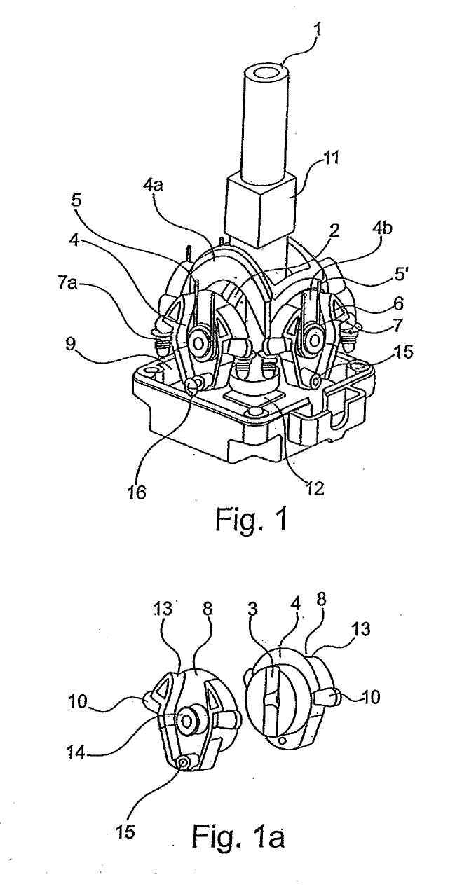

FIG. 1 shows a perspective view of the joystick according to the invention obliquely from above without the upper parts of the housing;

FIG. 1a shows the same view as FIG. 1 of the movement modules which are illustrated in isolation and which have a groove;

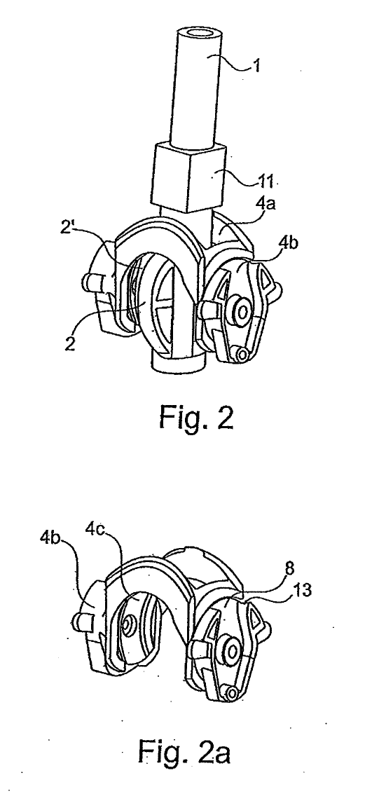

FIG. 2 shows the same view as FIG. 1 of the stick, the driver-bracket and the further movement modules connected to the latter;

FIG. 2a shows the same view as FIG. 2 but without the stick;

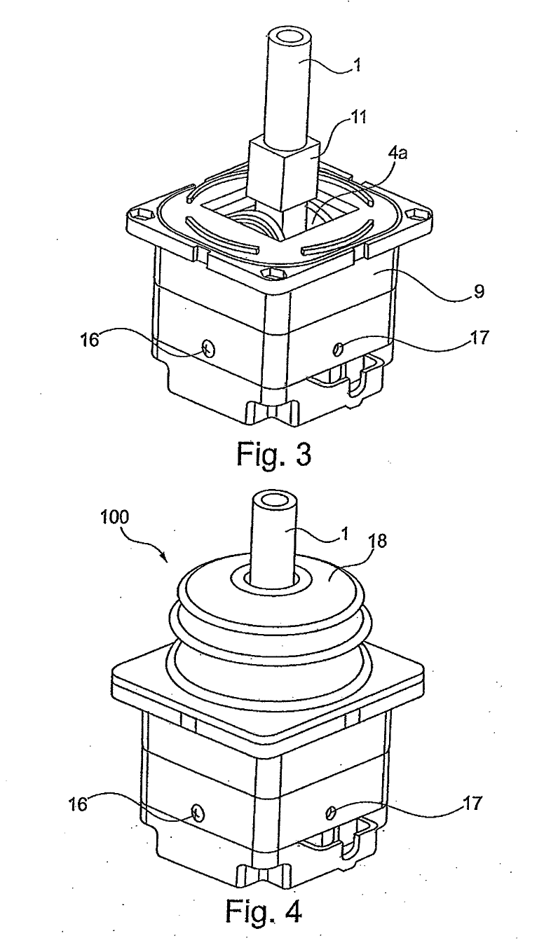

FIG. 3 shows the same view as FIG. 1 of the entire joystick without a protective cover;

FIG. 4 shows the same view as FIG. 1 of the complete joystick.

In the exemplary embodiment shown of the joystick according to the invention, denoted as a whole by 100, four uniform projections 2, 2′ are located in the lower region of the stick 1. The projections 2, 2′ extend in the longitudinal direction of the stick 1 and are perpendicular to one another. Two opposite projections are subsections of a single imaginary disk (i.e. of a rectilinear circular cylinder, of smaller thickness than the radius). Two opposite projections therefore form a circular outline through which the stick 1 passes.

Two opposite projections 2 of the four projections 2, 2′ are mounted in a sliding manner in a respective groove 3 in one of the two movement modules 4. The shape and size of the groove 3 is somewhat larger than the shape and size of the projection 2 located therein, and therefore there is a small amount of play and therefore movability of the projection in the groove. Each groove is therefore in the shape of the inner surface of part of a disk, the diameter and thickness of which is slightly larger than the diameter and the thickness of the disk, of which the projections form part. The groove 3 runs centrally through the stick-facing side of the two movement modules 4 having said groove. During tilting movements of the stick 1 toward said grooves 3 and away therefrom, the projections to which are guided therein slide in the grooves 3 without rotating the movement modules 4 which have said grooves. If the stick is tilted perpendicularly to said direction, the projections 2 rest in the grooves 3 and the movement modules 4 having the grooves rotate.

The two other, opposite projections 2′ do not engage in grooves, but rather instead engage in recesses 4c of further movement modules 4b, which recesses are in the form of a segment of a sphere. The two further, opposite movement modules 4b are connected to a driver-bracket 4a. It is revealed in FIG. 2a that the driver-bracket 4a is in the form of two archways which are arranged one behind the other in parallel and are connected at the sides thereof by two further archways of smaller size, thus resulting in the shape of a rectangle, as viewed from above. The driver-bracket 4a is arranged in such a manner that the longer extent of the upwardly pointing rectangle runs perpendicularly to the axis of rotation of the two movement modules 4 having a groove. As is furthermore revealed in FIG. 2a, the further movement modules 4b have mutually parallel edges which are enclosed in a form-fitting manner by the driver-bracket 4a in the manner of an open-end wrench. FIG. 2 shows that the stick 1 passes centrally through the driver-bracket 4a. If the stick 1 is tilted at least about the axis of the two further movement modules 4b which are connected to the driver-bracket 4a, said movement modules are rotated via the driver-bracket 4a. During movements of the stick perpendicular thereto, the stick 1 slides in the rectangular recess of the driver-bracket 4a without moving the latter and therefore the further movement modules 4b connected thereto. The stick 1 can be tilted in any direction, i.e. about two axes simultaneously. Each tilting movement results in the rotation of at least two movement modules 4, 4b.

The stick 1 is mounted, i.e. fixed in the longitudinal direction thereof, by the interaction of the four opposite projections 2, 2′ and the two grooves 3 and two recesses 4c in the shape of segment of a sphere.

A cylindrical projection 14 is arranged centrally in the stick-remote side of all four movement modules 4, 4b. The projection 14 has a bore through which spindles (not illustrated in the drawings) which extend inward from the housing 9 pass, thus resulting in the rotatable mounting of the movement modules 4, 4b. The movement modules 4, 4b are secured on said spindles from the inside by screws.

All four movement modules 4, 4b have a threaded bore 15 for the screw connection, which can be canceled again, with a blocking screw 16 through a bore 17 in the housing 9 such that, if the need arises, a tilting axis of the stick 1 can be blocked, as shown in FIGS. 3 and 4. The stick may also be completely blocked in this manner.

As FIG. 2 reveals, the projections 2, 2′ are screwed onto the stick 1 to make it easier to assemble the joystick 100.

The axes of rotation of the two opposite movement modules 4, 4b each coincide, intersect the longitudinal axis of the stick 1 and are perpendicular to said longitudinal axis, as viewed from the side. The axes of rotation of two opposite movement modules 4 are also perpendicular to the axes of rotation of the two remaining movement modules 4b.

A respective leg spring 5, 5′ together with the windings 7 thereof is placed around the projection 14 in the four movement modules 4, 4b. In the initial position of the stick 1, a stop edge 13 of the cutout 8 and a stop (not illustrated in the drawings) in the interior of the housing 9 lie in a line. The legs 6 of each leg spring 5, 5′ protrude out of a cutout 8 in each movement module 4, 4b and bear against stop edges of the cutout 8 and against the stops in the interior of the housing 9. By means of the stop edges 13 lying in a line in the initial position of the stick and by means of stops (not illustrated) in the interior of the housing 9, the legs 6 of the spring 5, 5′ are compressed, and the spring is prestressed. In the initial position of the stick 1, a spring force is not transmitted to the stick, since the leg forces, which act outward in opposite directions, on both sides of a recess are of equal size and therefore cancel each other out. One side of the cylindrical projection 14 is directly adjacent to the housing 9, and therefore the leg spring 5, 5′ cannot slip off said projection.

In order to bring about the restoring forces, eight helical springs 7a are provided in addition to the four leg springs 5, 5′. The leg springs 7a, of which only an upper and a lower subsection are depicted in FIG. 1, are supported on the housing base and extend on both sides of each movement module 4, 4b approximately to the height of the projection 14. At this height, drivers 10 are provided on each side of the movement modules 4, 4b, said drivers projecting laterally and stressing the helical springs 7a via punches which are placed therein and provide a supporting surface for the drivers 10. The helical springs 7a ensure that any tilting of the stick 1 out of an initial position causes restoring forces even if the leg spring 5, 5′ should fail.

The stick 1 has a cuboidal region 11 which, together with the stop edges of the opening of the housing cover, limits the movement of the stick.

As shown in FIGS. 1, 3 and 4, an aperture for a cable bushing is provided in the housing base, and a projection with a recess for relieving tension is provided in front of said aperture.

As is apparent from FIG. 4, the housing 9 is closed from above by a protective cover 18 which engages around the stick 1 and is fastened to a plate which is placed onto the housing 9.

An orthogonally magnetized magnet sits on the lower side of the stick 1 and produces the required position calculation signals in the Hall sensor 12 arranged centrally on the printed circuit board in the housing base.

The joystick 100 is connected via an internal communication bus. Communication with the vehicle in turn takes place via a CAN controller.

### LIST OF REFERENCE NUMBERS

100 Joystick
1 Stick
2, 2′ Projection
3 Groove
4 Movement module having a groove
4a Driver-bracket
4b Further movement module without a groove, connected to the driver-bracket
4c Recess in the shape of a segment of a sphere in the further movement module
5, 5′ Spring element
6 Leg of the leg spring
7 Winding of the leg spring
7a Helical spring
8 Cutout of the movement module
9 Housing
10 Driver of the helical spring
11 Cuboidal region of the stick
12 Hall sensor
13 Stop edge of the cutout of the movement module
14 Cylindrical projection
15 Threaded bore
16 Blocking screw
17 Bore in the housing
18 Protective cover

1. A joystick comprising:
first means for mounting of a stick (1) and for bringing about forces against tilting of the stick at least about a certain axis, said means comprising a stick (1) with at least one projection (2) which extends in the longitudinal direction of the stick and has an outline of a semicircle reduced by half the thickness of the stick and is guided in a sliding manner in a groove (3) which is matched to the shape of the projection (2) and is provided in at least one movement module (4), which is mounted rotatably in a housing (9) of the joystick, with an axis of rotation, the imaginary extension of which intersects the longitudinal axis of the stick and runs perpendicularly to the longitudinal axis, as viewed from the side,
at least one spring element (5), the force of which opposes rotation of the at least one movement module out of an initial position, and
other means which bring about a force against tilting of the stick out of an initial position at least about an axis which is perpendicular to the certain axis.

2. The joystick as claimed in claim 1,
wherein the other means comprise a tiltably mounted driver-bracket (4a) formed as two archways which are located one behind the other in parallel and are connected to each other by two further archways having spans at interposed between and smaller than the two archways,
wherein the stick reaches through a rectangle formed, as viewed from above, by the two archways and the two further archways,
wherein the driver-bracket is arranged such that the longer extent of the rectangle runs perpendicularly to the axis of rotation of the at least one movement module which has a groove, and
further comprising at least one spring element (5′), the force of which opposes tilting of the driver-bracket out of an initial position.

3. The joystick as claimed in claim 2, wherein the driver-bracket is connected at the sides to at least one further movement module (4b) mounted rotatably in a housing (9) of the joystick, and the force of the spring element opposes rotation of the further movement module out of the initial position.

4. The joystick as claimed in claim 3, wherein the further movement module (4b), which is connected to the driver-bracket (4a), has a recess (4c) formed as an inner surface of a segment of a sphere, the radius of which is somewhat larger than the radius of the semicircle of the outline of the projection (2′) which extends in the longitudinal direction of the stick (1) and has an outline of a semicircle reduced by half the thickness of the stick and which rests in a sliding manner in the recess.

5. The joystick as claimed in claim 1, wherein the movement module (4, 4b) is at least also mounted in a sliding manner over at least part of the lateral area thereof in the housing (9).

6. The joystick as claimed in claim 1, further comprising at least one movement module (4, 4b) configured to be selectively blocked by a fixing means (16) on the housing (9).

7. The joystick as claimed in claim 1, wherein the spring element (5, 5′) comprises a leg spring.

8. The joystick as claimed in claim 1, wherein the spring element (5, 5′) is configured of plastic.

9. The joystick as claimed in claim 7, wherein a region connecting legs (6) of the spring element has at least one winding (7) and is arranged around a cylindrical projection (14) of the movement module (4, 4b), wherein the projection has a bore, and wherein the bore, together with a complementary spindle which is provided on the housing (9) and reaches through said projection, forms a sliding bearing.

10. The joystick as claimed in claim 7, wherein the leg spring (5, 5′) is U-shaped and is provided with a region connecting the legs (6) of the leg spring in a slot provided in the projection (14).

11. The joystick as claimed in claim 7, wherein a region connecting the legs of the leg spring (5, 5′) is placed around a cylindrical projection (14) and surrounds the projection by more than half a circumference of the projection.

12. The joystick as claimed in claim 7, wherein the leg spring (5, 5′) is formed integrally with the movement modules (4, 4b).

13. The joystick as claimed in claim 7, wherein ends of the legs (6) of the leg spring have thickened portions configured to interact with stops on the housing (9).

14. The joystick as claimed in claim 7, wherein borders of cutouts (8) in the movement modules (4, 4b) are provided as stop edges (13) for the legs (6) of the leg spring (5, 5′).

15. The joystick as claimed in claim 1, wherein at least one helical spring (7a) is provided redundantly to the spring element (5, 5′).

16. The joystick as claimed in claim 1, further comprising a sensor (12) under the stick (1).

17. The joystick as claimed in claim 16, wherein the sensor (12) is a Hall sensor which interacts with a magnet arranged on a lower side of the stick (1).

18. A joystick comprising:
a stick having at least one lateral projection and forming in outline a circular section;
a first structure pivotably mounting the stick on a first axis;
at least one first tension element configured to counteract forces tilting the stick around the first axis out of a first rest position;
a second structure provided with a groove configured to receive the circular section such that the circular section slides in the groove when the stick pivots out of the rest position and about the first axis;
a driver bracket encircling the stick and mounted to a housing such that the stick and the driver bracket are mounted to pivot on a second axis that is at least substantially perpendicular to the first axis; and
at least one second tension element configured to counteract forces titling the stick and the driver bracket around the second axis out of the first rest position.
